(19) United States
(12) Patent Application Publication
(10) Pub. No.: US 2011/0153041 A1
(43) Pub. Date: Jun. 23, 2011

(54) CONNECTION SYSTEM

(75) Inventors: WEN-JUNG SU, HSINCHU COUNTY (TW); CHIEN-HSI CHEN, HSINCHU COUNTY (TW); CHIN-CHUAN HUANG, HSINCHU COUNTY (TW)

(73) Assignee: FEELING TECHNOLOGY CORP., HSINCHU COUNTY (TW)

(21) Appl. No.: 12/719,210

(22) Filed: Mar. 8, 2010

(30) Foreign Application Priority Data
Dec. 18, 2009 (TW) 098143569

(51) Int. Cl. G05B 15/00

(52) U.S. Cl. 700/83

(57) ABSTRACT

The connection system of the present invention includes a human-machine interface device and a host device. The human-machine interface device includes a signal generating module and a control module. The host device includes an operation module, an identification module and a system module. After the signal generating module generates an original working signal, the original working signal is sent to the operation module to generate a transforming signal via control module, and then the operation module sends the transforming signal back to the control module such that the control module generates a final working signal meeting an identification condition. Finally, the control module sends the final working signal to the identification module for identification such that the system module executes a predetermined work.

This application claims the benefit of Taiwan Patent Application Serial No. 098143569, filed on Dec. 18, 2009, the subject matter of which is incorporated herein by reference.

### FIELD OF THE INVENTION

The present invention relates to a connection system, and more particularly to a connection system for connecting a human-machine interface device to a host device.

### BACKGROUND OF THE INVENTION

Due to rapid development of the science and technology, the shelf life of electronic devices becomes shorter. New technology of hardware and software comes up very soon and performs greater every time. However, for research and develop personnel and manufacturing companies, it is an important issue to cut the cost down.

When a piece of hardware is connected to a host device of an electronic device, it must be identified by the host device—the function thereof is a driver. After the hardware is identified, signals generated and sent by the hardware can be received and utilized by the host device. The signals generated by the hardware must be compatible with the host device. For example, when a touch panel is in use, it generates coordinate signals of a cursor to the host device; however, since the users can adjust the resolution of a display anytime, the coordinate signals generated by the touch panel must to be transformable according to the resolution such that the touch panel can be compatible with the host device.

FIG. 1 is a block diagram showing a first embodiment of prior art connection system. The prior art connection system 100 includes a human-machine interface device 11 and a host device 12. The human-machine interface device 11 includes a signal generating module 111, a control module 112 and a first interface module 113. The host device 12 includes an operation identification module 121, a system module 122 and a second interface module 123.

When the signal generating module 111 generates and sends an original working signal S1 to the operation identification module 121 via the control module 112, the first interface module 113 and the second interface module 123, the operation identification module 121 must receive a system specification signal S2 sent by the system module 122 to perform an operation according to the system specification signal S2 and the original working signal S1 to generate a final working signal S3, and then sends the final working signal S3 to the system module 122 to execute a predetermined task.

Although manufacturing companies of operating system release drivers for the operation system, the drivers cannot perform the operations depending on the original signals inputted by the various hardware. Thus, the hardware companies have to develop drivers, i.e. the operation identification module 121, to perform the operations depending on the original working signals. However, developing drivers usually results in a lot of research and development resources. In particular, compatibilities among various system identification, hardware, and systems have always been a knotty problem to the R&D personnel. Moreover, whenever a new operating system is released, the hardware manufacturers have to develop new drivers for the new operating system, thereby decreasing the economic efficiency.

Referring to FIG. 2, a block diagram representing g a second embodiment of prior art is shown. In response to the above-mentioned problems, a prior art connection system 200 transmits an original working signal S4 to a human-machine interface device 21 to perform an operation. The prior art connection system 200 includes the human-machine interface device 21 and a host device 22. The human-machine interface device 21 includes a signal generating module 211, an operation control module 212 and a first interface module 213. The host device 22 includes an identification module 221, a system module 222 and a second interface module 223.

When the signal generating module 211 generates and transmits the original working signal S4 to the operation control module 212, the system module 222 must send a system specification signal S5 to the operation control module 212 via the identification module 221, the second interface module 223 and the first interface module 213. The operation control module 212 performs an operation according to the original working signal S4 and the system specification signal S5 to generate a final working signal S6, and then sends the final working signal S6 to the identification module 221 via the first interface module 213 and the second interface module 223 for identification. The final working signal S6 is then sent to the system module 222 to execute a predetermined task.

By doing so, the identification module 221 does not need to perform an operation on the original working signal S4. Therefore, the hardware companies can utilize the drivers provided by the manufacturers of operating systems and can reduce the research and development resources. However, the human-machine interface device 21 must include the operation control module 212 which can execute the original working signal S4. As a result, the hardware manufacturers have to manufacture new operation units with higher performance in the human-machine interface device 21, and the manufacturing cost is consequently increased.

Based on the above, if the drivers with customized operational functions are utilized, it will required a lost of research and development resources; if the operation units with operational functions are installed in the human-machine interface device, it will increase a relatively large amount of the manufacturing expense.

### SUMMARY OF THE INVENTION

The object of the present invention is to provide a connection system, and more particularly to a connection system for connecting a human-machine interface device to a host device. The connection system sends an original working signal generated by the human-machine interface device to an operation module of the host device to conduct an operation, sends the result of the operation back to the human-machine interface device, and an identification module of the host device for identification, thereby saving the hardware manufacturing costs of the human-machine interface device and simultaneously avoiding the identification module to conduct the identification process again.

The connection system of the present invention includes a human-machine interface device and a host device. The human-machine interface device includes a signal generating module and a control module. The host device includes an operation module, an identification module and a system module. After the signal generating module generates an original working signal, the original working signal is sent to the operation module to generate a transforming signal via control module, and then the operation module sends the transforming signal back to the control module such that the control module generates a final working signal meeting an identification condition. Finally, the control module sends the final working signal to the identification module for identification such that the system module executes a predetermined work.

In a preferable embodiment of the present invention, an operation module is utilized for receiving a system specification signal sent by a system module, and sending a transforming signal according to an original working signal and the system specification signal.

Compared with the conventional connection system, since the operation of the original working signal is performed by the operation module of the host device in the present invention, while saving the manufacturing costs of hardware of the human-machine interface device, the identification module does not need to conduct the identification process.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principals of the present invention.

FIG. 1 is a block diagram showing a first embodiment of prior art connection system;

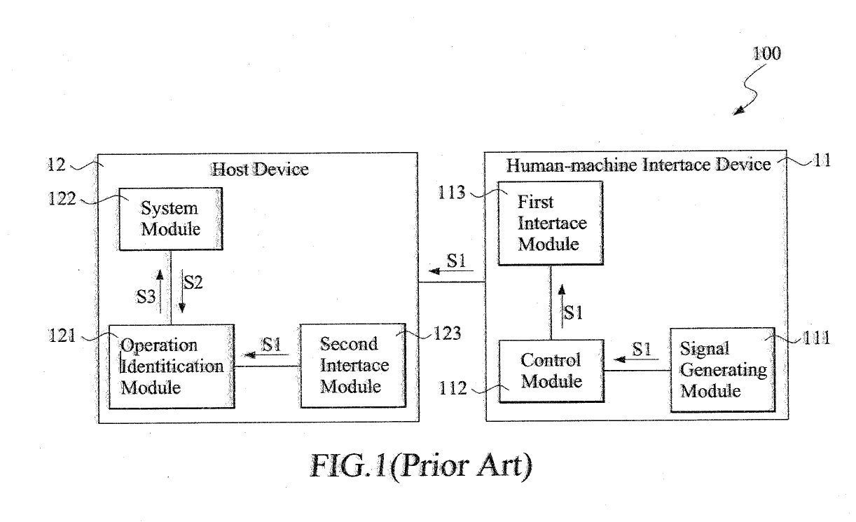

FIG. 2 is a block diagram showing a second embodiment of prior art connection system; and

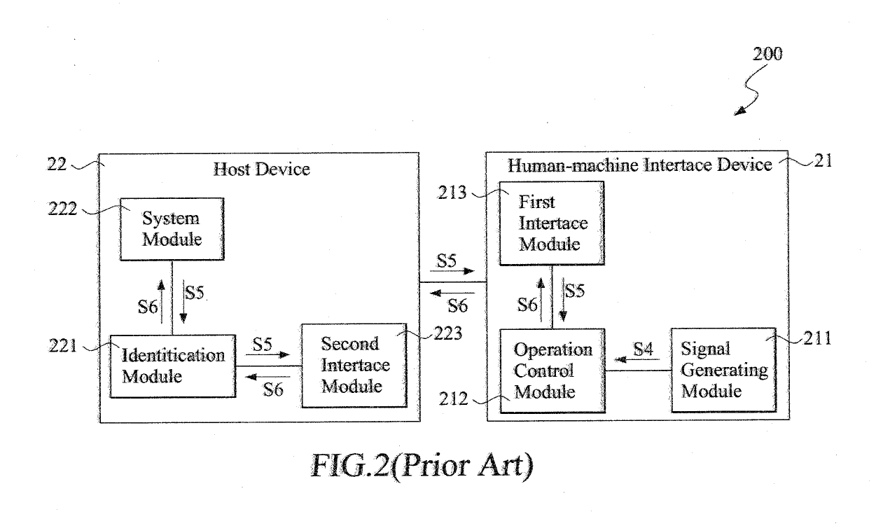

FIG. 3 is a block diagram showing the functions of a connection system according to the present invention.

### DETAILED DESCRIPTION OF THE PREFERRED EMBODIMENTS

The present invention relates to a connection system, and particularly relates to a connection system for connecting a human-machine interface device to a host device. A preferable embodiment of the present invention is as following. It is a common understanding for persons having ordinary skill in the art that a preferable embodiment is an example of the present invention and should not limit the invention itself.

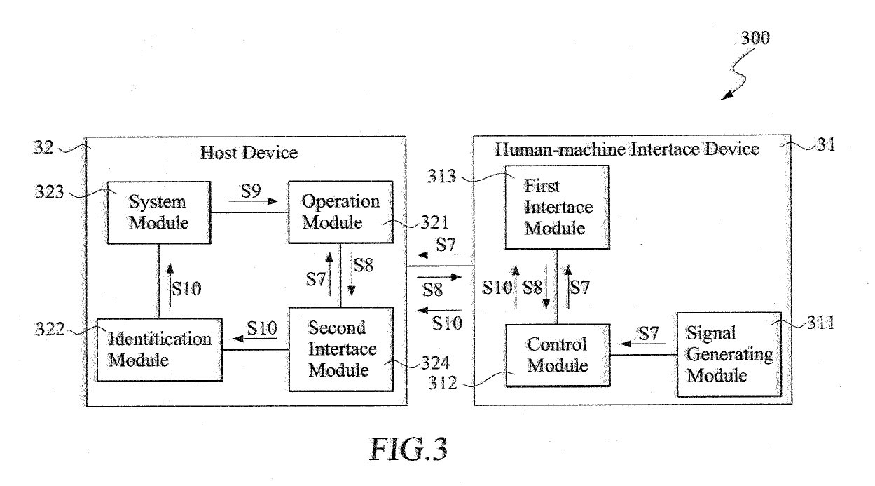

Referring to FIG. 3, a block diagram showing the functions of a connection system according to the present invention. The connection system 300 of the present invention includes a human-machine interface device 31 and a host device 32, wherein the human-machine interface device 31 includes a signal generating module 311 and a control module 312. The signal generating module 311 generates an original working signal S7. The control module 312 is electrically connected with the signal generating module 311 to receive and sends the original working signal S7 later. The human-machine interface device 31 can be any hardware connected to the host device 32. According to a present embodiment of the present invention, the human-machine interface device 31 is selected from the group of a mouse, a keyboard, and a touch panel, and the original working signal S7 is selected from the group of coordinate signals or any signals sent by hardware connected to the host device 32.

The host device 32 includes an operation module 321, an identification module 322 and a system module 323, the operation module 321 being electrically connected with the human-machine interface device 31 to receive the original working signal S7 and sends a transforming signal S8 accordingly. According to a preferable embodiment of the present invention, the operation module 321 is utilized to receive a system specification signal S9 sent by the system module 323 and sends the transforming signal S8 according to an operation result of the original working signal S7 and the system specification signal S9. The identification module 322 is electrically connected with the human-machine interface device 31 to determine an identification condition. The system module 323 is electrically connected with the identification module 322.

After the transforming signal S8 is sent to the control module 312, the control module 312 generates a finial working signal S10 corresponding to the identification condition and according to the transforming signal S8. The e final working signal S10 is sent to the identification module 322 for undergoing an identification process. Once the identification module 322 determines that the final working signal S10 meets the identification condition, the final working signal S10 is sent to the system module 323 for the system module 323 to execute a predetermined task.

Moreover, according to an embodiment of the present invention, the human-machine interface device 31 further includes a first interface module 313 electrically connected with the control module 312 to receive and send the original working signal S7, the transforming signal S8 and the final working signal S10. Furthermore, the first interface module 313 includes common communication protocols, and is selected from the group of Universal Serial Bus (USB), IEEE 1394, RS-232, and Serial Advanced Technology Attachment (SATA). The host device 32 includes a second interface module 324 electrically connected with the operation module 321 and the identification module 322 to receive and send the original working signal S7, the transforming signal S8 and the final working signal S10. According to a preferable embodiment of the present invention, the second interface module 324 is selected from the group of Universal Serial Bus (USB), IEEE 1394, RS-232, and Serial Advanced Technology Attachment (SATA).

Based on the above, it can be known that the connection system 300 of the present invention sends the original working signal S7 generated by the human-machine interface device 31 to the operation module 321 of the host device 32 for operation, and after sending the transforming signal S8 back to the human-machine interface device 31, the human-machine interface device 31 sends the final working signal S10 meeting the identification condition according to the transforming signal S8 to the identification module 322 of the host device 322 for undergoing an identification process. Since ordinary host devices 32 are equipped with the operation module 321 with high performance, no extra costs for the hardware of the host device 32 are increased. As a result, the manufacturing costs of hardware of the human-machine interface device 31 can be economized, the identification module 322 does not need to conduct the identification process again. The human-machine interface device 31 of the connection system 300 of the present invention is more competitive in the market.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A connection system comprising:
a human-machine interface device including
a signal generating module for generating an original working signal, and
a control module electrically connected with the signal generating module to receive and send the original working signal;
a host device including
an operation module electrically connected with the human-machine interface device to receive the original working signal and send a transforming signal accordingly,
an identification module electrically connected with the human-machine interface device, wherein an identification condition is predetermined by the identification module, and
a system module electrically connected with the identification module;
wherein, after the transforming signal is sent to the control module, the control module generates a finial working signal corresponding to the identification condition and according to the transforming signal, the final working signal is sent to the identification module for undergoing an identification process when the identification module determines that the final working signal meets the identification condition, the final working signal is sent to the system module for the system module to execute a predetermined task.

2. The connection system according to claim 1, wherein the human-machine interface device further includes a first interface module electrically connected to the control module to receive and send the original working signal, the transforming signal, and the final working signal.

3. The connection system according to claim 2, wherein the first interface module is selected from the group of Universal Serial Bus (USB), IEEE 1394, RS-232, and Serial Advanced Technology Attachment (SATA).

4. The connection system according to claim 1, wherein the host device further includes a second interface module electrically connected to the operation module and the identification module to receive and send the original working signal, the transforming signal, and the final working signal.

5. The connection system according to claim 4, wherein the second interface module is selected from the group of Universal Serial Bus (USB), IEEE 1394, RS-232, and Serial Advanced Technology Attachment (SATA).

6. The connection system according to claim 1, wherein the human-machine interface device is selected from the group of a mouse, a keyboard, and a touch panel.

7. The connection system according to claim 1, wherein the operation module further receives a system specification signal sent by the system module, and sends the transforming signal according to the original working signal and the system specification signal.
